(19) United States
(12) Patent Application Publication
(10) Pub. No.: US 2017/0226264 A1
(43) Pub. Date: Aug. 10, 2017

(54) Ageing-Resistant and Low-Emission Mattresses and/or Cushions

(71) Applicant: Evonik Degussa GmbH, Essen (DE)

(72) Inventors: Thomas Günther, Neuss (DE); Martin Glos, Borken (DE); Michael Krebs, Dusseldorf (DE)

(21) Appl. No.: 15/404,324

(22) Filed: Jan. 12, 2017

(30) Foreign Application Priority Data
Feb. 10, 2016 (EP) 16154988.6

(51) Int. Cl. C08G 18/20; C08G 18/24; A47C 27/14; C08G 18/76; C08J 9/00; A47C 7/18; C08G 18/08; C08G 18/48

(52) U.S. Cl. CPC C08G 18/2081; C08G 18/14; C08G 18/244; C08G 18/48; C08G 18/7621; C08J 9/00; A47C 7/18; A47C 27/144; A47C 27/148; C08G 2101/0083

(57) ABSTRACT

Ageing-resistant and low-emission mattresses and/or cushions comprising at least one section of flexible polyurethane foam, wherein the flexible polyurethane foam has been obtained by reaction of at least one polyol component and at least one isocyanate component in the presence of the compound of the formula (I)

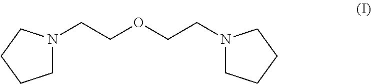 [SMILES: C1CCN(CCOCCN2CCCC2)C1]

and at least one blowing agent, are described.

The present invention is in the field of mattresses and/or cushions, in particular mattresses, and also flexible polyurethane foams. It preferably relates to the provision of mattresses and/or cushions, in particular mattresses, which comprise at least one section composed of flexible polyurethane foam.

Mattresses and/or cushions containing polyurethane foam have long been known from the prior art and are employed worldwide. There has been no lack of attempts to improve such mattresses and/or cushions ever further, for example in order to make optimal sleeping comfort possible. The need for optimization has not been fully satisfied to the present day.

A constantly occurring problem in the field of mattresses and/or cushions containing polyurethane foam continues to be the ageing behavior. During the ageing process, material fatigue can occur in mattresses and/or cushions. Here, for example, the hardness of the mattress and/or the cushion can change locally or distributed over the entire mattress. In most cases, a decrease in hardness is observed. This can result in formation of sleeping hollows or in hardness differences over the entire mattress. A poor mattress is not uncommonly the trigger for back problems, headaches or disturbed sleep.

The main cause of material fatigue is compression of the mattress and/or the cushion when it is laid on. Heat, moisture, UV radiation and also oxidation and degradation processes in the mattress material can likewise accelerate the process of material fatigue. This applies particularly to mattresses and/or cushions which contain flexible polyurethane foam. The heat resistance and/or ageing resistance of the polyurethane foams used when they are subjected to heat (heat ageing), in particular, still requires further improvement. Tertiary amines are generally used as catalysts in the production of such flexible PU foams, in particular in order to catalyze the reaction between isocyanate and polyol and isocyanate and water. Such compounds can therefore be effectively regarded as essential additives for the production of flexible PU foams. However, many of these amine catalysts usually have an adverse effect on the ageing resistance of PU foams. A further problem associated with mattresses and/or cushions containing polyurethane foam is the sometimes demanding requirements which the emission profile of these products has to meet. Amine emissions often make a major contribution to the total emission profile. In turn, the proportions of flexible polyurethane foam are in most cases responsible for the amine emissions of these mattresses and/or cushions containing polyurethane foam. It therefore remains a general challenge to produce low-emission and ageing-resistant flexible polyurethane foams as constituents of mattresses and/or cushions containing polyurethane foam.

In the light of this background, a specific object of the present invention was to provide polyurethane foam-containing mattresses and/or cushions which have particularly low amine emissions and at the same time have a particularly good ageing resistance.

For the purposes of the present invention, “low-emission” in respect of amines means, in particular, that the flexible polyurethane foam for producing mattresses and/or cushions, preferably for producing mattresses, has an amine emission of from ≧0 μg/m³ to ≦40 μg/m³, preferably ≦10 μg/m³, particularly preferably ≦5 μg/m³, determined appropriately by the test chamber method based on the DIN standard DIN EN ISO 16000-9:2008-04, 24 hours after loading the test chamber.

For the purposes of the present invention, “ageing-resistant” means, in particular, an improvement in the ageing behavior, in particular the heat resistance and/or ageing resistance on heating (heat ageing), of flexible polyurethane foams. Such ageing phenomena are often closely related to the choice of catalyst system for production of the flexible polyurethane foams, and generally lead to material fatigue.

In the context of the present invention, it has surprisingly been found that this object can be achieved by the subject matter of the invention. The invention provides a mattress and/or cushion comprising at least one section of flexible polyurethane foam, wherein the flexible polyurethane foam has been obtained by reaction of at least one polyol component and at least one isocyanate component in the presence of the compound of the formula (I)

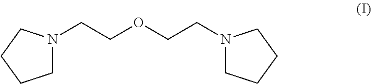 [SMILES: C1CCN(CCOCCN2CCCC2)C1]

and at least one blowing agent. Further customary additives, active materials and auxiliaries can naturally also optionally be used advantageously in the abovementioned reaction. Mattresses are very particularly preferred for the purposes of the invention. This also advantageously applies to all preferred embodiments below.

The flexible polyurethane foam produced in this way using a compound of the formula (I) is advantageously particularly low in amine emissions and at the same time particularly ageing-resistant, as can be verified, in particular, with the aid of the test methods as indicated in the examples. The heat resistance and/or durability of the corresponding flexible polyurethane foams can be advantageously improved when using the inventive nitrogen-containing compound of the formula (I) compared to flexible polyurethane foams produced using conventional catalysts according to the prior art. This positive effect can advantageously be observed in the case of, in particular, flexible polyurethane foams, preferably flexible slabstock foams, in particular in the context of dry heat ageing in accordance with the DIN standard DIN EN ISO 2440/A1:2009-01, in particular at a temperature of 70, 100, 120, 125 and/or 140° C. and an ageing time of 2, 4, 16, 22, 24, 48, 72 and/or 168 hours, preferably 2, 24 and/or 168 hours.

Mattresses per se and the production thereof are known. They usually consist of a mattress core, e.g. comprising foam, latex, natural products and/or a spring core, and a cover surrounding the mattress. A corresponding situation applies to cushions. The statement that at least a section of flexible polyurethane foam is present in the mattress and/or in the cushion means that at least part of the mattress and/or of the cushion consists of flexible polyurethane foam or various flexible polyurethane foams. Based on the total weight of the mattress and/or of the cushion, this part can make up at least 1% by weight or 5% by weight or 25% by weight, preferably at least 50% by weight, in particular at least 75% by weight. It is also possible for the mattress and/or the cushion to consist entirely of flexible polyurethane foam, apart from the cover.

The production of polyurethane foam is likewise known. It is formed by the tried and tested reaction of at least one polyol component and at least one isocyanate component in the presence of at least one blowing agent (e.g. water) in a polyaddition reaction. It is here essential to the present invention that this reaction is carried out in the presence of the compound of the formula (I)

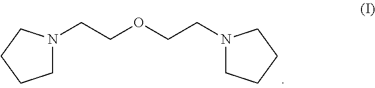 [SMILES: C1CCN(CCOCCN2CCCC2)C1]

The flexible polyurethane foam present in the mattress and/or the cushion is, according to a preferred embodiment of the invention, a hot-cured flexible polyurethane foam, a high-resilience flexible polyurethane foam or a viscoelastic flexible polyurethane foam, or use is made of a combination of these flexible foams, e.g. two or three of these flexible foams. The differentiation between the abovementioned flexible foam types is known per se to those skilled in the art; these are well-known technical terms which have become correspondingly established in the field, but will nevertheless be explained briefly here.

The critical difference between high-resilience flexible foam production and hot-cured flexible foam is that in the former case highly reactive polyols and optionally also low molecular weight crosslinkers are used, with the function of the crosslinkers also being able to be performed by relatively high-functionality isocyanates. Reaction of the isocyanate groups with the hydroxyl groups thus occurs as early as in the expansion phase (CO₂ formation from —NCO and H₂) of the foam. This rapid polyurethane reaction usually leads, as a result of a viscosity increase, to a relatively high intrinsic stability of the foam during the blowing process. High-resilience flexible polyurethane foams are usually highly elastic foams in which the outer zone stabilization plays a great role. Owing to the high intrinsic stability, the cells are generally not sufficiently opened at the end of the foaming process and they have to be additionally broken open mechanically. The force required here (“force to crush” (FTC)) is a measure of the proportion of open cells. Foams having a high proportion of open cells which require only a low force to crush are usually desirable. In foaming in a mound, high-resilience flexible polyurethane foams are, in contrast to hot-cured flexible polyurethane foams, produced at a temperature of, for example, ≦90° C.

Open-cell flexible polyurethane foams usually have a gas permeability (also referred to as “porosity”) in the range from 1 to 250 mm water column, in particular in the range from 1 to 50 mm water column (preferably determined by measuring the pressure difference when flow occurs through a foam specimen). For this purpose, a 5 cm thick foam disc is placed on a smooth base. A plate having a weight of 800 g (10 cm×10 cm) and a central hole (diameter 2 cm) and a hose connection is placed on the foam plate. Through the central hole, a constant air stream of 8 l/min is passed into the foam specimen. The more closed the foam is, the more pressure is built up and the more the surface of the water column is forced downward and the greater the values that are measured.

Hot-cured flexible foams usually have, depending on the application, a foam density in the range from 8 to 80 kg/m³. High-resilience flexible foams, particularly for the production of high-quality mattresses, are usually produced in a density range of 25-80 kg/m³. Here, a distinction is made according to regional circumstances, requirements and preferences of consumers, in particular, when using such foams as mattresses, mattress constituents and/or cushions.

A key feature of high-resilience flexible foams is the rebound resilience (also known as “ball rebound” (BR) or “resilience”). A method of determining the rebound resilience is described, for example, in DIN EN ISO 8307:2008-03. Here, a steel ball having a fixed mass is allowed to fall from a particular height onto the test specimen and the height of the rebound in % of the drop height is then measured. Typical values for a high-resilience flexible foam are usually in the range of ≧55%. High-resilience flexible foams are thus also often referred to as HR foams. In comparison, hot-cured flexible polyurethane foams have rebound values of usually from 15% to a maximum of 60%.

A specific class of polyurethane foams is that of viscoelastic foams. These are also known by the name of “memory foam” and display both a low rebound resilience (preferably <10%) and also a slow, gradual recovery after compression (recovery time preferably 2-10 s). Materials of this kind are well known in the prior art and are highly valued for, in particular, their energy- and sound-absorbing properties. Typical viscoelastic foams usually have a low porosity and a high density (or a high foam density (FD)) compared to conventional flexible polyurethane foams. Cushions have a foam density of usually 30-50 kg/m³ and are thus at the lower end of the density scale typical of viscoelastic foams, whereas mattresses usually have a density in the range of 60-130 kg/m³.

In conventional polyurethane foams, the hard (high glass transition temperature) and soft (low glass transition temperature) phases become arranged next to one another during the polymerization and then spontaneously separate from one another to form morphologically different phases within the “bulk polymer”. Such materials are also referred to as “phase-separated” materials. In this context, viscoelastic polyurethane foams are a special case where the above-described phase separation occurs only incompletely, if at all. The glass temperature in the case of viscoelastic foams is preferably in the range from −20 to +15° C., while the glass transition temperature of hot-cured flexible polyurethane foams and high-resilience flexible polyurethane foams is in contrast usually below −35° C. Such “structural viscoelasticity” which is based mainly on the glass temperature of the polymer should be distinguished from viscoelasticity of polyurethane foams having (predominantly) open cells, which is attributable to a pneumatic effect. This is because, in the latter case, virtually closed cells, i.e. only slightly opened cells, are present within the foam material. As a result of the small size of the orifices, the air flows back in only gradually after compression, which results in slowed recovery.

Various flexible polyurethane foams are classified not only according to the foam density but often also according to their compressive strength, also referred to as load-bearing capacity, for particular applications. Thus, the compressive strength CLD (compression load deflection), 40% in accordance with DIN EN ISO 3386-1:2015-10, of hot-cured flexible polyurethane foams is usually in the range of 2.0-8.0 kPa. High-resilience flexible foams generally have values of from 2.0 to 5.0 kPa, in particular from 2.5 to 4.5 kPa, while viscoelastic polyurethane foams usually have values of 0.1-5.0 kPa, in particular 0.5-2.0 kPa.

In a preferred embodiment of the invention, the flexible polyurethane foams to be used according to the invention have the following preferred properties in respect of rebound resilience, foam density and/or porosity (optionally after pressing open the foams, particularly in the case of high-resilience flexible polyurethane foam), namely a rebound resilience of from 1 to 80%, measured in accordance with DIN EN ISO 8307:2008-03, and/or a foam density of from 5 to 150 kg/m³ and/or a porosity of from 1 to 250 mm water column, in particular from 1 to 50 mm water column. Particular preference is given to all 3 criteria in respect of rebound resilience, foam density and/or porosity, as indicated above, being satisfied. In particular, the flexible polyurethane foam used according to the invention has a compressive strength CLD, 40% in accordance with DIN EN ISO 3386-1:2015-10, of from 0.1 to 8.0 kPa.

Hot-cured flexible polyurethane foam, high-resilience flexible polyurethane foam and viscoelastic flexible polyurethane foam and the production thereof are known per se. For the purposes of the present invention, hot-cured flexible polyurethane foam has, in particular, a compressive strength CLD, 40% in accordance with DIN EN ISO 3386-1:2015-10, of 2.0-8.0 kPa and/or a rebound resilience of 15-60%, measured in accordance with DIN EN ISO 8307:2008-03, and/or a foam density of from 8 to 80 kg/m³ and/or a porosity of from 1 to 250 mm water column, in particular from 1 to 50 mm water column. A possible production method is described, for example, in EP 2 481 770 A2 or EP 2 182 020 A1. For the purposes of the present invention, high-resilience flexible polyurethane foam has, in particular, a compressive strength CLD, 40% in accordance with DIN EN ISO 3386-1:2015-10, of 2.0-5.0 kPa, in particular 2.5-4.5 kPa, and/or a rebound resilience of ≧55%, measured in accordance with DIN EN ISO 8307:2008-03, and/or a foam density of from 25 to 80 kg/m³ and/or a porosity (after pressing open the foam) of from 1 to 250 mm water column, in particular from 1 to 50 mm water column. A possible method of production is described, for example, in EP 1777252 B1. For the purposes of the present invention, viscoelastic flexible polyurethane foam has, in particular, a glass transition temperature in the range from −20 to +15° C. and/or a compressive strength CLD, 40% in accordance with DIN EN ISO 3386-1:2015-10, of 0.1-5.0 kPa, in particular 0.5-2.0 kPa, and/or a rebound resilience of <10%, measured in accordance with DIN EN ISO 8307:2008-03, and/or a foam density of from 30 to 130 kg/m³ and/or a porosity (after pressing open the foam) of from 1 to 250 mm water column, in particular from 1 to 50 mm water column. A possible method of production is described, for example, in WO 2013/131710 A2. The glass transition temperature can be measured using dynamic mechanical analysis (DMA) (DIN 53513:1990-03) or using differential scanning calorimetry (DSC) (ISO 11357-2:2013). What is measured is strictly speaking a glass transition range which extends over a temperature range.

The mattress of the invention has, in a preferred embodiment of the invention, a height of from at least 1 cm to not more than 50 cm and a width of from at least 20 cm to not more than 300 cm and a length of from at least 20 cm to not more than 300 cm. Preferred dimensions are, for example, heights in the range from 5 cm to 40 cm, widths in the range from 70 cm to 200 cm, lengths in the range from 150 cm to 220 cm. The cushion of the invention has, in a preferred embodiment of the invention, a height of from at least 1 cm to not more than 40 cm and a width of from at least 15 cm to not more than 200 cm and a length of from at least 15 cm to not more than 200 cm. Preferred dimensions are, for example, heights in the range from 2 cm to 30 cm, widths in the range from 15 cm to 50 cm, lengths in the range from 15 cm to 50 cm.

In a further preferred embodiment of the invention, it is configured as a multizone mattress. The different zones differ in terms of, in particular, the respective hardness. Such multizone mattresses and the production thereof are known per se. They are widely sold commercially. In particular, the mattress has up to seven zones of differing hardness which extend over the longitudinal direction of the mattress and are given the appropriate width. When the mattress has various hardness zones distributed over its area, which are formed, in particular, by cuts and/or hollow spaces in the mattress, this constitutes a further preferred embodiment of the invention.

In a further preferred embodiment of the invention, the mattress of the invention can be a high-resilience polyurethane foam mattress, a viscoelastic flexible polyurethane foam mattress, a hot-cured polyurethane foam mattress, a polyurethane gel-foam mattress, a latex mattress or a box-spring mattress. These types of mattress are known per se to those skilled in the art and are also marketed worldwide under these names. Hot-cured foam mattresses are usually referred to on the market as foam mattresses in the interests of simplicity. The term mattress as used for the purposes of the invention also encompasses corresponding mattress coverings and underlays.

The provision of the various PUR foams which can be used in the context of the present invention is known per se and it is possible to make recourse to all proven processes, with the proviso that the PUR foam is produced in the presence of the compound of the formula (I). The production of corresponding PUR foams in principle requires no further explanation, but some preferred details of the production of the PUR foam used for the purposes of the invention are given below. The subject-matter of the invention will be described by way of example below, without the invention being restricted to these illustrative embodiments. When ranges, general formulae or classes of compounds are specified below, these are intended to encompass not only the corresponding ranges or groups of compounds which are explicitly mentioned but also all subranges and subgroups of compounds which can be derived by leaving out individual values (ranges) or compounds. When documents are cited in the context of the present description, the contents thereof, particularly with regard to the subject matter that forms the context in which the document has been cited, are considered in their entirety to form part of the disclosure content of the present invention. Unless stated otherwise, percentages are figures in per cent by weight. When average values are reported below, the values in question are weight averages, unless stated otherwise. When parameters which have been determined by measurement are reported below, the measurements have been determined at a temperature of 25° C. and a pressure of 101.325 Pa, unless stated otherwise.

For the purposes of the present invention, polyurethanes are all reaction products derived from isocyanates, in particular polyisocyanates, and appropriately isocyanate-reactive molecules. These include polyisocyanurates, polyureas, and allophanate-, biuret-, uretdione-, uretonimine- or carbodiimide-containing isocyanate or polyisocyanate reaction products. It goes without saying that a person skilled in the art seeking to produce the various flexible polyurethane foams, for example hot-cured, high-resilience or viscoelastic flexible polyurethane foams, can appropriately select the substances which are necessary for the purpose in each case, for example isocyanates, polyols, stabilizers, surfactants, etc., in order to obtain the desired type of polyurethane, in particular type of polyurethane foam. Further details of the starting materials, catalysts and auxiliaries and additives used can be found, for example, in Kunststoffhandbuch [Plastics Handbook], volume 7, Polyurethane [Polyurethanes], Carl-Hanser-Verlag Munich, 1st edition 1966, 2nd edition 1983 and 3rd edition 1993. The compounds, components and additives which follow are mentioned merely by way of example and can be replaced and/or supplemented by other substances known to those skilled in the art.

The isocyanate components used are preferably one or more organic polyisocyanates having two or more isocyanate functions. Polyol components used are preferably one or more polyols having two or more isocyanate-reactive groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Preferably, isocyanates are used within a range from 60 to 350 mol %, more preferably within a range from 60 to 140 mol %, relative to the sum total of the isocyanate-consuming components.

Specific examples are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3-and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates can be used individually or in the form of mixtures thereof.

It is also possible to use isocyanates which have been modified by the incorporation of urethane, uretdione, isocyanurate, allophanate and other groups, called modified isocyanates.

Particularly suitable organic polyisocyanates which are therefore particularly preferably employed are various isomers of tolylene diisocyanate (tolylene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Polyols suitable as polyol component for the purposes of the present invention are all organic substances having two or more isocyanate-reactive groups, preferably OH groups, and also formulations thereof. Preferred polyols are all polyether polyols and/or polyester polyols and/or hydroxyl-containing aliphatic polycarbonates which are customarily used for producing polyurethane systems, in particular polyurethane foams, in particular polyether polycarbonate polyols and/or filled polyols (polymer polyols) such as SAN, PHD and PIPA polyols which contain solid organic fillers up to a solids content of 40% or more in dispersed form, and/or autocatalytic polyols which contain catalytically active functional groups, in particular amino groups, and/or polyols of natural origin, known as “natural oil-based polyols” (NOPs). The polyols usually have a functionality of from 1.8 to 8 and number average molecular weights in the range from 500 to 15 000. The polyols having OH numbers in the range from 10 to 1200 mg KOH/g are usually employed. The number average molecular weights are typically determined by gel permeation chromatography (GPC), especially using polypropylene glycol as reference substance and tetrahydrofuran (THF) as eluent. The OH numbers can be determined, in particular, in accordance with the DIN standard DIN 53240:1971-12. Depending on the required properties of the resulting foams, it is possible to use appropriate polyols, as described for example in: US 2007/0072951 A1, WO 2007/111828, US 2007/0238800, U.S. Pat. No. 6,359,022 or WO 96/12759. Further polyols are known to those skilled in the art and can be found, for example, in EP-A-0380993 or US-A-3346557.

One preferred embodiment of the invention, in particular for production of molded and high-resilience flexible foams, utilizes two- and/or three-functional polyether alcohols having primary hydroxyl groups, preferably above 50%, more preferably above 80%, in particular those having an ethylene oxide block at the chain end. According to the required properties of this embodiment which is preferred in accordance with the invention, especially for production of the abovementioned foams, preference is given to using not only the polyether alcohols described here but also further polyether alcohols which bear primary hydroxyl groups and are based predominantly on ethylene oxide, in particular having a proportion of ethylene oxide blocks of >70%, preferably >90%. All polyether alcohols described in the context of this preferred embodiment preferably have a functionality of from 2 to 8, particularly preferably from 2 to 5, number average molecular weights in the range from 2500 to 15 000, preferably from 4500 to 12 000, and usually OH numbers in the range from 5 to 80, preferably from 20 to 50 mg KOH/g.

A further preferred embodiment of the invention, in particular for production of flexible slabstock foam, utilizes two- and/or three-functional polyether alcohols having secondary hydroxyl groups, preferably above 50%, more preferably above 90%, in particular those having a propylene oxide block or random propylene oxide and ethylene oxide block at the chain end, or those based exclusively on propylene oxide blocks. Such polyether alcohols preferably have a functionality of from 2 to 8, particularly preferably from 2 to 4, number average molecular weights in the range from 500 to 8000, preferably from 800 to 5000, particularly preferably from 2500 to 4500, and usually OH numbers in the range from 10 to 100, preferably from 20 to 60 mg KOH/g.

In a further preferred embodiment of the invention, particularly for producing molded and highly elastic flexible foams, autocatalytic polyols are used.

In a further preferred embodiment of the invention, especially for production of viscoelastic polyurethane foams, preference is given to using mixtures of various, preferably two or three, polyfunctional polyester alcohols and/or polyether alcohols. The polyol combinations used here usually consist of a low molecular weight “crosslinker” polymer having a high functionality, preferably having an OH number of from 100 to 270 mg KOH/g, and/or a conventional high molecular weight flexible slabstock foam polyol or HR polyol and/or a “Hypersoft” polyether polyol, preferably having an OH number of from 20 to 40 mg KOH/g, with a high proportion of ethylene oxide and having cell-opening properties.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 10 to 1000, preferably 40 to 350, more preferably 70 to 140. An index of 100 represents a molar reactive group ratio of 1:1.

Depending on the application, it can be preferred according to the invention for additional catalysts to be used in addition to the inventive compound of the formula (I).

The expression “additional catalysts” encompasses, for the purposes of the present invention, all compounds known from the prior art which are able to catalyze isocyanate reactions and/or are used as catalysts, cocatalysts or activators in the production of polyisocyanate reaction products, in particular polyurethane foams.

Suitable additional catalysts for the purposes of the present invention include, for example, substances that catalyze one of the abovementioned reactions, in particular the gelling reaction (isocyanate with polyol), the blowing reaction (isocyanate with water) and/or the dimerization or trimerization of the isocyanate. Such catalysts are preferably nitrogen compounds, especially amines and ammonium salts, and/or metal compounds.

Examples of suitable additional nitrogen-containing compounds as catalysts for the purposes of the present invention are the amines triethylamine, N,N-dimethylcyclohexylamine, N,N-dicyclohexylmethylamine, N,N-dimethylaminoethylamine, N,N,N′,N′-tetramethylethylene-1,2-diamine, N,N,N′,N′-tetramethylpropylene-1,3-diamine, N,N,N′,N′-tetramethyl-1,4-butanediamine, N,N,N′,N′-tetramethyl-1,6-hexanediamine, N,N,N′,N″,N″-pentamethyldiethylenetriamine, N,N,N′-trim ethylaminoethylethanolamine, N,N-dimethylaminopropylamine, N,N-diethylaminopropylamine, 1-(2-aminoethyl)pyrrolidine, 1-(3-aminopropyl)pyrrolidine, N,N-dimethylaminopropyl-N′,N′-dipropan-2-olamine, 2-[[3-(dimethylamino)propyl]methylamino]ethanol, 3-(2-dimethylamino)ethoxypropylamine, N,N-bis[3-(dimethylamino)propyl]amine, N,N,N′,N″,N″-pentamethyldipropylenetriamine, 1-[bis[3-(dimethylamino)propyl]amino]-2-propanol, N,N-bis[3-(dimethylamino)propyl]-N′,N′-dimethylpropane-1,3-diamine, triethylenediamine, 1,4-diazabicyclo[2.2.2]octane-2-methanol, N,N′-dimethylpiperazine, 1,2-dimethylimidazole, N-(2-hydroxypropyl)imidazole, 1-isobutyl-2-methylimidazole, N-(3-aminopropyl)imidazole, N-methylimidazole, N-ethylmorpholine, N-methylmorpholine, 2,2,4-trimethyl-2-silamorpholine, N-ethyl-2,2-dimethyl-2-silamorpholine, N-(2-aminoethyl)morpholine, N-(2-hydroxyethyl)morpholine, bis(2-morpholinoethyl) ether, N,N′-dimethylpiperazine, N-(2-hydroxyethyl)piperazine, N-(2-aminoethyl)piperazine, N,N-dimethylbenzylamine, N,N-dimethylaminoethanol, N,N-diethylaminoethanol, 1-(2-hydroxyethyl)pyrrolidine, 3-dimethylamino-1-propanol, 1-(3-hydroxypropyl)pyrrolidine, N,N-dimethylaminoethoxyethanol, N,N-diethylaminoethoxyethanol, bis(2-dimethylaminoethyl) ether, N,N,N′-trimethyl-N′-(2-hydroxyethyl)bis(2-aminoethyl) ether, N,N,N′-trimethyl-N-3′-aminopropyl(bisaminoethyl ether), tris(dimethylaminopropyl)hexahydro-1,3,5-triazine, 1,8-diazabicyclo[5.4.0]undec-7-ene, 1,5-diazabicyclo[4.3.0]non-5-ene, 1,5,7-triazabicyclo[4.4.0]dec-5-ene, N-methyl-1,5,7-triazabicyclo[4.4.0]dec-5-ene, 1,4,6-triazabicyclo[3.3.0]oct-4-ene, 1,1,3,3-tetramethylguanidine, tert-butyl-1,1,3,3-tetramethylguanidine, guanidine, 3-dimethylaminopropylurea, 1,3-bi s[3-(dimethylamino)propyl]urea, bis-N,N-(dimethylaminoethoxyethyl)isophorone dicarbamate, 3-dimethylamino-N,N-dimethylpropionamide and 2,4,6-tris(dimethylaminomethyl)phenol. Suitable additional nitrogen-containing catalysts known from the prior art can be procured, for example, from Evonik under the trade name TEGOAMIN®.

Suitable metal-containing compounds as additional catalysts can, for example, be selected from the group consisting of metal-organic or organometallic compounds, metal-organic or organometallic salts, organic metal salts, inorganic metal salts and from the group consisting of charged or uncharged metal-containing coordination compounds, in particular metal chelate complexes. The expression “metal-organic or organometallic compounds” in the context of this invention especially encompasses the use of metal compounds having a direct carbon-metal bond, also referred to here as metal organyls (e.g. tin organyls) or organometallic compounds (e.g. organotin compounds). The expression “organometallic or metal-organic salts” in the context of this invention especially encompasses the use of metal-organic or organometallic compounds having salt character, i.e. ionic compounds in which either the anion or cation is organometallic in nature (e.g. organotin oxides, organotin chlorides or organotin carboxylates). The expression “organic metal salts” in the context of this invention especially encompasses the use of metal compounds which do not have any direct carbon-metal bond and are simultaneously metal salts, in which either the anion or the cation is an organic compound (e.g. tin(II) carboxylates). The expression “inorganic metal salts” in the context of this invention especially encompasses the use of metal compounds or of metal salts in which neither the anion nor the cation is an organic compound, e.g. metal chlorides (e.g. tin(II) chloride), pure metal oxides (e.g. tin oxides) or mixed metal oxides, i.e. containing a plurality of metals, and/or metal silicates or aluminosilicates. The expression “coordination compound” in the context of this invention especially encompasses the use of metal compounds made up of one or more central particles and one or more ligands, with the central particles being charged or uncharged metals (e.g. metal- or tin-amine complexes). For the purposes of the present invention, the expression “metal-chelate complexes” encompasses especially the use of metal-containing coordination compounds which have ligands having at least two coordination or bonding positions to the metal center (e.g. metal- or tin-polyamine or metal- or tin-polyether complexes). Suitable metal compounds, especially as defined above, as additional catalysts for the purposes of the present invention may, for example, be selected from all metal compounds containing lithium, sodium, potassium, magnesium, calcium, scandium, yttrium, titanium, zirconium, vanadium, niobium, chromium, molybdenum, tungsten, manganese, cobalt, nickel, copper, zinc, mercury, aluminum, gallium, indium, germanium, tin, lead and/or bismuth, especially sodium, potassium, magnesium, calcium, titanium, zirconium, molybdenum, tungsten, zinc, aluminum, tin and/or bismuth, more preferably tin, bismuth, zinc and/or potassium.

Suitable metal-containing coordination compounds include, for example, any metal acetylacetonates such as nickel(II) acetylacetonate, zinc(II) acetylacetonate, copper(II) acetylacetonate, molybdenum dioxoacetylacetonate, any iron acetylacetonates, any cobalt acetylacetonates, any zirconium acetylacetonates, any titanium acetylacetonates, any bismuth acetylacetonates and any tin acetylacetonates. Particularly suitable organometallic salts and organic metal salts, particularly as defined above, as additional catalysts for the purposes of the present invention, are, for example, organotin, tin, zinc, bismuth and potassium salts, especially corresponding metal carboxylates, alkoxides, thiolates and mercaptoacetates, for example dibutyltin diacetate, dimethyltin dilaurate, dibutyltin dilaurate (DBTDL), dioctyltin dilaurate (DOTDL), dimethyltin dineodecanoate, dibutyltin dineodecanoate, dioctyltin dineodecanoate, dibutyltin dioleate, dibutyltin bis-n-laurylmercaptide, dimethyltin bis-n-laurylmercaptide, monomethyltin tris-2-ethylhexylmercaptoacetate, dimethyltin bis-2-ethylhexylmercaptoacetate, dibutyltin bis-2-ethylhexylmercaptoacetate, dioctyltin bisisooctylmercaptoacetate, tin(II) acetate, tin(II) 2-ethylhexanoate (tin(II) octoate), tin(II) isononanoate (tin(II) 3,5,5-trimethylhexanoate), tin(II) neodecanoate, tin(II) ricinoleate, zinc(II) acetate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, bismuth acetate, bismuth 2-ethylhexanoate, bismuth octoate, bismuth isononanoate, bismuth neodecanoate, potassium formate, potassium acetate, potassium 2-ethylhexanoate (potassium octoate), potassium isononanoate, potassium neodecanoate and/or potassium ricinoleate. Suitable additional metallic catalysts are generally and preferably selected such that they do not have any troublesome intrinsic odor and are essentially toxicologically safe, and such that the resulting polyurethane systems, especially polyurethane foams, have a minimum level of catalyst-related emissions.

Apart from additional amines and metal compounds, it is also possible to use ammonium salts as additional catalysts. Suitable examples are ammonium formate and/or ammonium acetate.

Suitable additional catalysts are mentioned, for example, in DE 102007046860, EP 1985642, EP 1985644, EP 1977825, US 2008/0234402, EP 0656382 B1 and US 2007/0282026 A1, and the patent documents cited therein.

Suitable amounts of additional catalysts used are guided by the type of catalyst and are preferably in the range from 0.01 to 10.0 pphp, more preferably in the range from 0.02 to 5.00 pphp (=parts by weight based on 100 parts by weight of polyol) or 0.10 to 10.0 pphp for potassium salts.

The compound of the formula (I) can, for example, be used together with suitable solvents and/or further additives. As optional solvents, it is possible to employ all suitable substances known from the prior art. Depending on the application, it is possible to use aprotic nonpolar, aprotic polar and protic solvents. Suitable aprotic nonpolar solvents can, for example, be selected from the following classes of substances, or classes of substances containing the following functional groups: aromatic hydrocarbons, aliphatic hydrocarbons (alkanes (paraffins) and olefins), carboxylic esters and polyesters, (poly)ethers and/or halogenated hydrocarbons having a low polarity. Suitable aprotic polar solvents can, for example, be selected from the following classes of substances, or classes of substances containing the following functional groups: ketones, lactones, lactams, nitriles, carboxamides, sulphoxides and/or sulphones. Suitable protic solvents can, for example, be selected from the following classes of substances, or classes of substances containing the following functional groups: alcohols, polyols, (poly)alkylene glycols, amines, carboxylic acids, in particular fatty acids and/or primary and secondary amides. Particularly preferred solvents are compounds which can be processed without any problem in the foaming operation and do not adversely affect the properties of the foam. For example, isocyanate-reactive compounds are suitable, since they are incorporated into the polymer matrix by reaction and do not generate any emissions in the foam. Examples are OH-functional compounds such as (poly)alkylene glycols, preferably monoethylene glycol (MEG or EG), diethylene glycol (DEG), triethylene glycol (TEG), 1,2-propylene glycol (PG), dipropylene glycol (DPG), trimethylene glycol (propane-1,3-diol, PDO), tetramethylene glycol (butanediol, BDO), butyl diglycol (BDG), neopentyl glycol, 2-methylpropane-1,3-diol (Ortegol CXT) and higher homologues thereof, for example polyethylene glycol (PEG) having average molecular masses between 200 and 3000. Particularly preferred OH-functional compounds further include polyethers having average molecular masses of 200 to 4500, in particular 400 to 2000, among these preferably water-, allyl-, butyl- or nonyl-initiated polyethers, in particular those which are based on propylene oxide (PO) and/or ethylene oxide (EO) blocks.

When the compound of the formula (I) is used, or premixed catalyst combinations of the compound of the formula (I) with additional catalysts are used, in dissolved form or used in combination with a solvent, the mass ratio of the sum total of all catalysts to solvent is preferably in the range from 100:1 to 1:4, preferably from 50:1 to 1:3 and more preferably from 25:1 to 1:2.

Optional additives used may be all substances which are known according to the prior art and find use in the production of polyurethanes, especially of polyurethane foams, for example blowing agents, preferably water for formation of CO₂, and, if necessary, further physical blowing agents, crosslinkers and chain extenders, stabilizers against oxidative degradation (called antioxidants), flame retardants, surfactants, biocides, cell-refining additives, cell openers, solid fillers, antistatic additives, nucleating agents, thickeners, dyes, pigments, color pastes, fragrances, emulsifiers, buffer substances and/or additional catalytically active substances, especially as defined above.

Water is generally used as blowing agent in the production of flexible polyurethane foams. Preference is given to using such an amount of water that the water concentration is from 0.10 to 25.0 pphp (pphp=parts by weight based on 100 parts by weight of polyol).

It is also possible to use suitable physical blowing agents. These are, for example, liquefied CO2 and volatile liquids, for example hydrocarbons having 3, 4 or 5 carbon atoms, preferably cyclopentane, isopentane and n-pentane, oxygen-containing compounds such as methyl formate, acetone and dimethoxymethane, or chlorinated hydrocarbons, preferably dichloromethane and 1,2-dichloroethane.

Apart from water and the physical blowing agents, it is also possible to use other chemical blowing agents which react with isocyanates to evolve a gas, for example formic acid.

Optional crosslinkers and optional chain extenders are low molecular weight, polyfunctional compounds which are reactive toward isocyanates. Suitable compounds are, for example, hydroxyl- or amine-terminated substances such as glycerol, neopentyl glycol, 2-methyl-1,3-propanediol, triethanolamine (TEOA), diethanolamine (DEOA) and trimethylolpropane. The use concentration is usually in the range from 0.1 to 5 parts, based on 100 parts of polyol, but can also deviate therefrom depending on the formulation. When crude MDI is used in in-situ foaming, it likewise assumes a crosslinking function. The content of low molecular weight crosslinkers can therefore be reduced correspondingly with an increasing amount of crude MDI.

Suitable optional stabilizers against oxidative degradation, called antioxidants, are preferably all standard free-radical scavengers, peroxide scavengers, UV absorbers, light stabilizers, complexing agents for metal ion contaminants (metal deactivators). Preference is given to using compounds of the following classes of substances, or classes of substances containing the following functional groups, with substituents on the respective parent molecules preferably being, in particular, substituents which have groups which are reactive toward isocyanate: 2-(2′-hydroxyphenyl)benzotriazoles, 2-hydroxybenzophenones, benzoic acids and benzoates, phenols, in particular comprising tert-butyl and/or methyl substituents on the aromatic entity, benzofuranones, diarylamines, triazines, 2,2,6,6-tetramethylpiperidines, hydroxylamines, alkyl and aryl phosphites, sulphides, zinc carboxylates, diketones.

Suitable optional flame retardants in the context of this invention are all substances which are regarded as suitable for this purpose according to the prior art. Preferred flame retardants are, for example, liquid organophosphorus compounds such as halogen-free organophosphates, e.g. triethyl phosphate (TEP), halogenated phosphates, for example tris(1-chloro-2-propyl) phosphate (TCPP) and tris(2-chloroethyl) phosphate (TCEP), and organic phosphonates, for example dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine.

The foam properties of polyurethane foams can optionally be influenced in the course of production thereof using, in particular, siloxanes or organomodified siloxanes, for which it is possible to use the substances known in the prior art. Preference is given to using compounds which are particularly suitable for the respective foam types (rigid foams, hot-cured flexible foams, viscoelastic foams, ester foams, high-resilience flexible foams (HR foams), semirigid foams). Suitable (organomodified) siloxanes are described for example in the following documents: EP 0839852, EP 1544235, DE 102004001408, EP 0839852, WO 2005/118668, US 20070072951, DE 2533074, EP 1537159, EP 533202, U.S. Pat. No. 3,933,695, EP 0780414, DE 4239054, DE 4229402, EP 867465. These compounds may be prepared as described in the prior art. Suitable examples are described, for instance, in U.S. Pat. No. 4,147,847, EP 0493836 and U.S. Pat. No. 4,855,379.

As optional (foam) stabilizers, it is possible to use all stabilizers known from the prior art. Preference is given to using foam stabilizers based on polydialkylsiloxane-polyoxyalkylene copolymers, as generally used in the production of urethane foams. The structure of these compounds is preferably such that, for example, a long-chain copolymer of ethylene oxide and propylene oxide is bonded to a polydimethylsiloxane radical. The linkage between the polydialkylsiloxane and the polyether moiety may be via an SiC linkage or an Si-O-C bond. In structural terms, the polyether or the different polyethers may be bonded to the polydialkylsiloxane in terminal or lateral positions. The alkyl radical or the various alkyl radicals can here be aliphatic, cycloaliphatic or aromatic. Methyl groups are very particularly advantageous. The polydialkylsiloxane may be linear or else contain branches. Suitable stabilizers, especially foam stabilizers, are described inter alia in U.S. Pat. No. 2,834,748, U.S. Pat. No. 2,917,480 and in U.S. Pat. No. 3,629,308. Suitable stabilizers can be purchased from Evonik Industries AG under the TEGOSTAB® trade name.

The siloxanes may also be used, in the context of the present invention (especially in the context of the inventive use), as part of compositions with different carrier media. Useful carrier media include, for example, glycols, for example monoethylene glycol (MEG), diethylene glycol (DEG), propylene glycol (PG) or dipropylene glycol (DPG), alkoxylates or oils of synthetic and/or natural origin.

The siloxanes may preferably be added to the composition for producing polyurethane foams in such an amount that the proportion by mass of the siloxanes in the finished polyurethane foam is from 0.01 to 10% by weight, preferably from 0.1 to 3% by weight.

It can be advantageous in the production of the flexible polyurethane foam to produce and/or use a composition which comprises at least one inventive compound of the formula (I), at least one polyol component, optionally at least one isocyanate component and optionally one or more blowing agents and to react this composition. Particular preference is given to using compositions which comprise the materials or components which have been described above for use in producing flexible polyurethane foams, in particular hot-cured, high-resilience and viscoelastic foams of this type.

The inventive compound of the formula (I) expressly encompasses, for the purposes of the present invention, the corresponding quaternized and/or protonated compounds. However, the use of the compound of the formula (I) which has not been quaternized or protonated is particularly preferred according to the present invention. For possible quaternization of the compound of the formula (I), it is possible to use any reagents known as quaternizing reagents. Preference is given to using alkylating agents such as dimethyl sulphate, methyl chloride or benzyl chloride, preferably methylating agents such as, in particular, dimethyl sulphate, as quaternizing agents. Quaternization can likewise be carried out using alkylene oxides, such as ethylene oxide, propylene oxide or butylene oxide, preferably with subsequent neutralization using inorganic or organic acids. The compounds of the formula (I), if quaternized, may be singly or multiply quaternized. Preferably, the compound of the formula (I) is only singly quaternized. In the case of single quaternization, the compound of the formula (I) is preferably quaternized on a nitrogen atom which is part of a ring, preferably a pyrrolidine ring. The compound of the formula (I) can be converted into the corresponding protonated compound by reaction with organic or inorganic acids. These protonated compounds may be preferable, for example, when, for example, a slowed polyurethane reaction is to be achieved or when the reaction mixture is to have enhanced flow behavior in use. As organic acids, it is possible to use, for example, all organic acids mentioned below, for example carboxylic acids having from 1 to 36 carbon atoms (aromatic or aliphatic, linear or branched), for example formic acid, lactic acid, 2-ethylhexanoic acid, salicylic acid and neodecanoic acid, or else polymeric acids such as polyacrylic or polymethacrylic acids. As inorganic acids, it is possible to use, for example, phosphorus-based acids, sulphur-based acids or boron-based acids.

The molar ratio of the total amount of the nitrogen-containing catalysts, comprising the compound of the formula (I) and also additional amine catalysts, to the total amount of the isocyanate-reactive groups of the polyol component is preferably from 4×10⁻⁴:1 to 0.2:1.

The nitrogen-containing compound of the formula (I) is preferably used in a total amount corresponding to a proportion by mass of from 0.01 to 20.0 parts (pphp), preferably from 0.01 to 5.00 parts and particularly preferably from 0.02 to 3.00 parts, based on 100 parts (pphp) of polyol component.

The production of the polyurethane foams according to the invention can be carried out by all methods with which a person skilled in the art is familiar, for example in manual mixing processes or preferably with the aid of foaming machines, in particular low-pressure or high-pressure foaming machines. Batch processors or continuous processors can be used here.

It is possible to use all processes known to those skilled in the art for production of polyurethane foams. For example, the foaming operation can be effected either in the horizontal or in the vertical direction, in batchwise plants or continuous plants. The compositions employed according to the present invention are similarly useful for CO2 technology. Use in low-pressure and high-pressure machines is possible, with the compositions to be processed being able to be metered directly into the mixing chamber or be admixed even before the mixing chamber with one of the components which then go into the mixing chamber. Admixture in the raw material tank is also possible.

A very particularly preferred flexible polyurethane foam for the purpose of the present invention has, in particular, the following composition:

| Component | Parts by weight (pphp) |
|---|---|
| Polyol | 100 |
| (Amine) catalyst | 0.05 to 5 |
| Tin catalyst | 0 to 5, preferably from 0.001 to 2 |
| Potassium catalyst | 0 to 10 |
| Siloxane | 0.1 to 15, preferably from 0.2 to 7 |
| Water | 0 to <25, preferably from 0.1 to 15 |
| Blowing agent | 0 to 130 |
| Flame retardant | 0 to 70 |
| Fillers | 0 to 150 |
| Further additives | 0 to 20 |
| Isocyanate index: | greater than 15 |

The present invention further provides for the use of flexible polyurethane foams in mattresses and/or cushions, in particular mattresses, wherein the flexible polyurethane foam has been obtained by reaction of at least one polyol component and at least one isocyanate component in the presence of the compound of the formula (I)

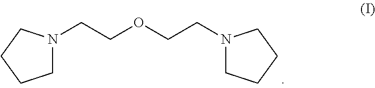 [SMILES: C1CCN(CCOCCN2CCCC2)C1]

In this respect, reference may be made, in particular, to what has been said above, which is also applicable to this subject matter.

The use according to the invention makes it possible to provide mattresses and/or cushions having improved ageing resistance and improved emission behavior.

### EXAMPLES

Physical properties of the flexible polyurethane foams:

The flexible polyurethane foams produced were assessed by means of the following physical properties:
a) dropping back of the foam after the end of the rise phase (=settling): The settling, or the further rise, is found from the difference of the foam height after direct blow-off and after 3 minutes after foam blow-off. The foam height is measured at the maximum in the middle of the foam crest by means of a needle secured to a centimeter scale. A negative value here describes the settling of the foam after blow-off; a positive value correspondingly describes the further rise of the foam.
b) Foam height: The final height of the foam is determined by subtracting the settling from or adding the further rise to the foam height after blow-off. Foam height is reported in centimeters (cm).
c) Foam density (FD): The determination is effected, as described in ASTM D 3574-11 under Test A, by measuring the core density. Foam density is reported in kg/m³.
d) Porosity: The gas permeability of the foam was determined by dynamic pressure measurement on the foam. The dynamic pressure measured is reported in mm water column, and lower dynamic pressure values characterize a more open foam. The values were measured in the range from 0 to 300 mm.
The dynamic pressure was measured by means of an apparatus comprising a nitrogen source, reducing valve with pressure gauge, flow regulating screw, wash bottle, flow meter, T-piece, applicator nozzle and a graduated glass tube filled with water. The applicator nozzle has an edge length of 100×100 mm, a weight of 800 g, an internal diameter of the outlet opening of 5 mm, an internal diameter of the lower applicator ring of 20 mm and an external diameter of the lower applicator ring of 30 mm.
The measurement is carried out by setting the nitrogen admission pressure to 1 bar by means of the reducing valve and setting the flow rate to 480 l/h. The amount of water in the graduated glass tube is set so that no pressure difference is built up and none can be read off. For the measurement on the test specimen having dimensions of 250×250×50 mm, the applicator nozzle is laid onto the corners of the test specimen, flush with the edges, and also once onto the (estimated) middle of the test specimen (in each case on the side having the greatest surface area). The result is read off when a constant dynamic pressure has been established.
Evaluation is effected by forming the average of the five measurements obtained.
e) Compressive strength CLD, 40% in accordance with DIN EN ISO 3386-1:2015-10. The measured values are reported in kilopascals (kPa).

Determination of the room temperature emission by the test chamber test (PC):

The emission, in particular the catalysis-related emissions or their decomposition or reaction products, of the foams obtained was determined at room temperature by a procedure based on the

DIN method DIN EN ISO 16000-9:2008-04. Sampling took place after 24 hours. For this purpose, 2 liters of the test chamber atmosphere were passed at a flow rate of 100 ml/min through an adsorption tube packed with Tenax® TA (mesh 35/60). The procedure for carrying out the thermal desorption with subsequent coupled gas chromatography/mass spectrometry (GC-MS) is described below.
a) Measurement technique: The thermal desorption was carried out using a “TDS2” thermal desorber with autosampler from Gerstel, Mülheim, in conjunction with an Agilent 7890/5975 GC/MSD system.
b) The measurement conditions are indicated in Tables 1 and 2.

TABLE 1
Thermal desorption measurement parameters
for test chamber measurement.

| | |
|---|---|
| Thermal desorption | Gerstel TDS2 |
| Desorption temperature | 280° C. |
| Desorption time | 5 min |
| Flow rate | 65 ml/min |
| Transfer line | 280° C. |
| Cryofocusing | KAS 4 |
| Liner | glass evaporator tube with silanized |
| | glass wool |
| Temperature | −150° C. |

TABLE 2
Gas chromatography/mass spectrometry measurement
parameters for test chamber measurement.

| | |
|---|---|
| GC | capillary - GC Agilent 7890 |
| Temperature programme | −150° C.; 1 min; [symbol] 10° C./sec; 280° C. |
| Column | Agilent 19091B-115, Ultra 2, 50 m * |
| | 0.32 mm dF 0.5 μm |
| Flow rate | 1.3 ml/min const. Flow |
| Temperature programme | 50° C.; 2 min; [symbol] 3° C./min; 92° C.; |
| | [symbol] 5° C./min; 160° C.; [symbol] 10° C./min; 280° C., |
| | 20 min |
| Detector | Agilent MSD 5975 |
| Evaluation: | Evaluation of the total ion current |
| | chromatogram by calculation as toluene |
| | equivalent |

c) For calibration, 2 μl of a mixture of toluene and hexadecane in methanol (each 0.125 mg/ml) were placed in a cleaned adsorption tube filled with Tenax® TA (mesh 35/60) and measured (desorption 5 min; 280° C.).

### Flexible Foam—Foaming Examples

### Example 1

### Production of Flexible Polyurethane Foams (Flexible Slabstock Foam)

The performance testing of the compound of the formula (I) was carried out using the foam formulation indicated in table 3.

TABLE 3
Formulation 1 for flexible slabstock foam applications.

| Formulation 1 | Parts by mass (pphp) |
|---|---|
| Polyol 1¹⁾ | 100 parts |
| Water | 3.00 parts |
| Tin catalyst²⁾ | 0.20 part |
| Amine | 0.20 part |
| TEGOSTAB ® BF 2370³⁾ | 0.80 part |
| Desmodur ® T 80⁴⁾ (tolylene diisocyanate | 38.1 parts |
| T80) | |

¹⁾Polyol 1: glycerol-based polyether polyol having an OH number of 48 mg KOH/g.
²⁾KOSMOS ® 29, obtainable from Evonik Industries: tin(II) salt of 2-ethylhexanoic acid.
³⁾Polyether-modified polysiloxane.
⁴⁾T 80 tolylene diisocyanate (80% 2,4 isomer, 20% 2,6 isomer) from Bayer, 3 mPa · s, 48% NCO, functionality 2.

In the foaming operation, 500 g of polyol were used; the other formulation constituents were adjusted correspondingly. Here, for example, 1.00 part of a component means 1.00 g of a substance per 100 g of polyol.

The foams were produced by manual mixing. The formulation 1 as indicated in Table 3 was employed using various amine catalysts. For this purpose, polyol, conventional or inventive nitrogen-containing catalyst (amine), tin catalyst, water and foam stabilizer were weighed into a cup and mixed at 1000 rpm for 60 seconds. After addition of the isocyanate (TDI), the reaction mixture was stirred at 2500 rpm for 7 s and immediately transferred into a paper-lined box (27 cm×27 cm base area and 27 cm height). To assess the catalytic properties, the following characteristic parameters were determined: Rise time, rise height and dropping back of the foam after the end of the rise phase (=settling).

Defined foam bodies were cut from the resulting foam blocks and were analyzed further. The following physical properties were determined on the specimens: foam density (FD), porosity (=air permeability) and compressive strength CLD (40%).

The results of the evaluation of the catalytic properties of the inventive nitrogen-containing compound of the formula (I) and also the physical properties of the resulting flexible slabstock foams are collated in Table 4. As comparative catalysts according to the prior art, use was made of triethylenediamine, 33% strength by weight solution in dipropylene glycol (TEGOAMIN® 33, obtainable from Evonik Industries), 2-[2-(dimethylamino)ethoxy]ethanol (TEGOAMIN® DMEE, obtainable from Evonik Industries) and bis(2-dimethylaminoethyl) ether, 70% strength by weight solution in dipropylene glycol (TEGOAMIN® BDE, obtainable from Evonik Industries). 0.20 pphp (=parts by weight based on 100 parts by weight of polyol) of amine was used in each case.

TABLE 4
Results of foaming of the formulation 1 (Table 3).

| | | | | | | Compressive |
|---|---|---|---|---|---|---|
| | | | | | | strength |
| | Rise | Settling | Height | FD | Porosity | (CLD 40%) |
| Amine | time [s] | [cm] | [cm] | [kg/m³] | [mm]¹⁾ | [kPa] |
| TEGOAMIN ® 33 | 119 | 0.2 | 28.9 | 31.2 | 18 | 4.1 |
| TEGOAMIN ® | 133 | 0.1 | 28.1 | 30.9 | 13 | 3.7 |
| DMEE | | | | | | |
| TEGOAMIN ® BDE | 92 | 0.5 | 28.3 | 30.8 | 10 | 3.4 |
| FORMULA (I) | 98 | 0.6 | 28.2 | 31.0 | 13 | 3.4 |

¹⁾= (dynamic pressure in mm water column).

As can be seen from Table 4, the inventive compound of the formula (I) displays a high catalytic activity and selectivity in respect of the blowing reaction, which is apparent from the comparison with the unbalanced TEGOAMIN® 33. The highly selective activity of the catalysis in respect of the blowing reaction is almost comparable with that of TEGOAMIN® BDE and considerably better than that of TEGOAMIN® DMEE. The physical evaluation of the resulting foams also shows, for example in respect of the proportion of open cells, that the compound of the formula (I) is a highly selective and highly active blowing catalyst.

### Example 2

### Emissions from Flexible Slabstock Polyurethane Foams

In order to study the influence of the compound of the formula (I) on the foam emissions, use was made of the foam formulation indicated in Table 5, which contains a low-emission polyol and a low-emission tin catalyst.

TABLE 5
Formulation 2, foam emissions in flexible slabstock foam applications.

| Formulation 2 | Parts by mass (pphp) |
|---|---|
| Polyol 1¹⁾ | 100 parts |
| Water | 3.00 parts |
| Tin catalyst²⁾ | 0.60 part |
| Amine | 0.15 part |
| TEGOSTAB ® BF 2370³⁾ | 0.80 part |
| Desmodur ® T 80⁴⁾ (tolylene diisocyanate | 41.6 parts |
| T80) | |

¹⁾Polyol 1: Low-emission glycerol-based polyether polyol having an OH number of 56 mg KOH/g.
²⁾KOSMOS ® EF, obtainable from Evonik Industries: Tin(II) salt of ricinoleic acid.
³⁾Polyether-modified polysiloxane.
⁴⁾T 80 tolylene diisocyanate (80% 2,4 isomer, 20% 2,6 isomer) from Bayer, 3 mPa · s, 48% NCO, functionality 2.

In the foaming operation, 500 g of polyol were used; the other formulation constituents were adjusted correspondingly. Here, for example, 1.00 part of a component means 1.00 g of a substance per 100 g of polyol.

Foaming was carried out by manual mixing. Formulation 2 as specified in Table 5 containing various amine catalysts was used. For this purpose, low-emission polyol, conventional or inventive nitrogen-containing catalyst (amine), low-emission tin catalyst, water and foam stabilizer were weighed into a cup and mixed at 1000 rpm for 60 seconds. After addition of the isocyanate (TDI), the reaction mixture was stirred at 2500 rpm for 7 s and immediately transferred into a paper-lined box (27 cm×27 cm base area and 27 cm height) and the resulting foam was, after blow-off, sealed in an airtight manner in polyethylene film. After a curing phase of 24 hours, a defined foam cube (7 cm×7 cm×7 cm) was cut from the resulting foam block and was completely enclosed in aluminum foil and additionally sealed by means of polyethylene film.

The emission characteristics of the above-described foams were subsequently examined at room temperature by the test chamber test based on the DIN method DIN EN ISO 16000-9:2008-04 as described above. The results are shown in Table 6.

TABLE 6
Emissions from the flexible slabstock foams from
Formulation 2 (Table 5)

Content of
volatile organic
compounds by the
test chamber test

| | TCₜₒₜ¹⁾ | TCₐₘᵢₙₑ¹⁾ |
|---|---|---|
| Amine | [μg/m³] | [μg/m³] |
| TEGOAMIN ® 33 | 93 | 61 |
| TEGOAMIN ® DMEE | 27 | <10 |
| TEGOAMIN ® BDE | 292 | 260 |
| FORMULA (I) | <20 | <10 |

¹⁾TCₜₒₜ = total emission; TCₐₘᵢₙₑ = emissions of all volatile amines or amine constituents in the test chamber test.

Table 6 shows that the amine emissions can surprisingly be reduced when use is made of the compound of the formula (I) compared to unreactive amines such as TEGOAMIN® BDE or TEGOAMIN® 33 and similar values are obtained as with incorporable, VOC-optimized amines such as TEGOAMIN® DMEE. Particularly compared to the use of TEGOAMIN® BDE, flexible polyurethane slabstock foams having significantly reduced amine emissions can thus be produced by alternative use of the compound of the formula (I); in this case even foams which are free or virtually free of amine emissions are obtained. In addition, as can be seen from Table 4 (Example 1), the rise time can be significantly shortened compared to reactive amines such as TEGOAMIN® DMEE when the compound of the formula (I) is used, which in combination represents a considerable advantage in the use for producing flexible slabstock foams. The compound of the formula (I) thus represents a highly active, blowing-selective and low-emission amine catalyst.

### Example 3

### Ageing of Flexible Polyurethane Slabstock Foams

Flexible slabstock foams for ageing tests in accordance with the DIN standard DIN EN ISO 2440/A1:2009-01 were produced in a manner analogous to Example 1 by means of formulation 1 (Table 3). Dry heat ageing at 140° C. (oven) for 2 hours was selected as ageing method. A foam cube (10 cm×10 cm×5 cm) which was suitable for calculating the compressive strength CLD, 40% in accordance with DIN EN ISO 3386-1:2015-10, served as test specimen. Firstly, for comparative purposes, the compressive strength before ageing was determined on a suitable test specimen from the same foam block. The compressive strength was, when possible, likewise determined for the aged test specimens. The low-emission amine catalyst 2-[2-(dimethylamino)ethoxy]ethanol (TEGOAMIN® DMEE, obtainable from Evonik Industries) was used as comparative catalyst according to the prior art. The results are compiled in Table 7.

TABLE 7
Change in the compressive strength of flexible slabstock
foams before and after dry heat ageing.

| | CLD 40% before | CLD 40% after ageing |
|---|---|---|
| Amine | ageing [kPa] | [kPa] |
| TEGOAMIN ® DMEE | 3.6 | 2.3 |
| FORMULA (I) | 3.5 | 3.4 |

It can be seen from Table 7 that, regardless of the amine catalyst selected, both test specimens had a comparable compressive strength before dry heat ageing. When the compound of the formula (I) was used, no significant deterioration in the compressive strength was observed after heat ageing either. This was unexpected since low-emission catalysts generally lead to impaired ageing properties of the foam. This is also shown by the example of the low-emission catalyst TEGOAMIN® DMEE, where a significant decrease in the compressive strength after ageing was measured. In the case of TEGOAMIN® DMEE, the heat ageing selected even led to considerable destruction of the foam structure. This was likewise not observed when using the compound of the formula (I). The compound of the formula (I) thus represents a highly active, very blowing-selective, low-emission amine catalyst for the production of ageing-resistant flexible polyurethane foams.

The advantageous nature of the invention was also confirmed in the case of other types of foam, e.g. high-resilience flexible foams (slabstock and molded foams).

Preparation of the inventive compound of the formula (I)

### Synthesis Example 1

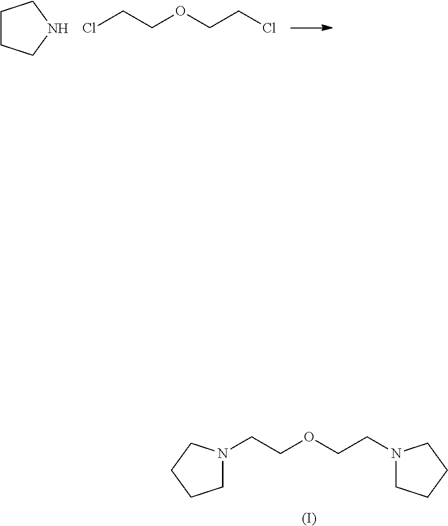

| Chemical | CAS | Supplier |
|---|---|---|
| 2-Chloroethyl ether, 99% | 111-44-4 | Sigma-Aldrich |
| | | Chemie GmbH |
| | | Munich |
| Pyrrolidine, >99% | 123-75-1 | Sigma-Aldrich |
| | | Chemie GmbH |
| | | Munich |

26.74 g (0.187 mol) of 2-chloroethyl ether were placed in a 250 ml laboratory autoclave equipped with a stirrer, a heatable jacket, pressure gauge and temperature sensor and also an inert gas inlet line and admixed with an amount of 120.0 g (1.68 mol) of pyrrolidine. After making the laboratory autoclave inert by means of nitrogen, the autoclave was heated to a jacket temperature of 60° C. for 12 hours, with no significant pressure rise being able to be observed. A reduced pressure of 20 mbar was then applied in order to remove unreacted starting material for the purpose of deactivation. The laboratory autoclave was then flushed with nitrogen and the reaction residue was subjected to a fine distillation in a diaphragm pump vacuum. After large amounts of unreacted pyrrolidone had gone over in the course of the process, an amount of 22.23 g of the product, corresponding to a yield of 56%, could be driven over in the target fraction at 15 mbar and a temperature at the top of 161° C. The reaction bottoms, which contained large amounts of quaternized by-product, crystallized on cooling to give a brown, salt-like mass. The 13C-NMR and also GC-MS analysis of the target fraction corresponded to expectations and confirmed formation of the product.

1. A Mattress and/or cushion comprising at least one section of flexible polyurethane foam, wherein the flexible polyurethane foam is the reaction product of at least one polyol component and at least one isocyanate component in the presence of the compound of the formula (I) 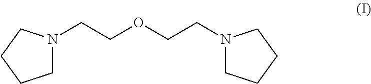 [SMILES: C1CCN(CCOCCN2CCCC2)C1]
and at least one blowing agent.

2. The mattress and/or cushion according to claim 1, wherein the flexible polyurethane foam is a hot-cured flexible polyurethane foam, a high-resilience flexible polyurethane foam or a viscoelastic flexible polyurethane foam, or in that a combination of these flexible foams is used.

3. The mattress and/or cushion according to claim 1, wherein the flexible polyurethane foam has a rebound resilience of 1-80%, measured in accordance with DIN EN ISO 8307:2008-03, and/or a foam density of from 5 to 150 kg/m³ and/or a porosity, optionally after pressing open the foams, of from 1 to 250 mm water column.

4. The mattress and/or cushion according to claim 1, wherein the flexible polyurethane foam has a compressive strength CLD, 40% in accordance with DIN EN ISO 3386-1:2015-10 of from 0.1 to 8.0 kPa.

5. The mattress and/or cushion according to claim 1, wherein the flexible polyurethane foam is a hot-cured flexible polyurethane foam and has a compressive strength CLD, 40% in accordance with DIN EN ISO 3386-1:2015-10 of 2.0-8.0 kPa, and/or a rebound resilience of 15-60%, measured in accordance with DIN EN ISO 8307:2008-03, and/or a foam density of from 8 to 80 kg/m³ and/or a porosity of from 1 to 250 mm water column.

6. The mattress and/or cushion according to claim 1, wherein the flexible polyurethane foam is a high-resilience flexible polyurethane foam and has a compressive strength CLD, 40% in accordance with DIN EN ISO 3386-1:2015-10, of 2.0-5.0 kPa, and/or a rebound resilience of ≧55%, measured in accordance with DIN EN ISO 8307:2008-03, and/or a foam density of 25 to 80 kg/m³ and/or a porosity, after pressing open the foam, of from 1 to 250 mm water column.

7. The mattress and/or cushion according to claim 1, wherein the flexible polyurethane foam is a viscoelastic flexible polyurethane foam and preferably has a glass transition temperature in the range from −20 to +15° C. and/or a compressive strength CLD, 40% in accordance with DIN EN ISO 3386-1:2015-10, of 0.1-5.0 kPa, and/or a rebound resilience of <10%, measured in accordance with DIN EN ISO 8307:2008-03, and/or a foam density of from 30 to 130 kg/m³ and/or a porosity, after pressing open the foam, of from 1 to 250 mm water column.

8. The mattress according to claim 1, wherein it has a height of from at least 1 cm to not more than 50 cm and a width of from at least 20 cm to not more than 300 cm.

9. The mattress according to claim 1, wherein the mattress is configured as multizone mattress.

10. The mattress according to claim 1, wherein the mattress has different hardness zones distributed over its area, which are formed, in particular, by cuts and/or hollow spaces in the mattress.

11. The mattress according to claim 1, wherein the mattress is a high-resilience foam mattress, a viscoelastic mattress, a gel-foam mattress, a latex mattress or a box-spring mattress.

12. The use of flexible polyurethane foam in mattresses and/or cushions, in particular mattresses, wherein the flexible polyurethane foam has been is the reaction product of at least one polyol component and at least one isocyanate component in the presence of the compound of the formula (I)

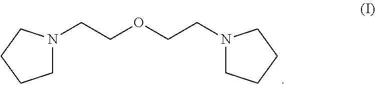 [SMILES: C1CCN(CCOCCN2CCCC2)C1]

13. The use according to claim 12 for providing mattresses and/or cushions having improved ageing resistance and improved emission behavior.

14. The mattress and/or cushion according to claim 2, wherein the flexible polyurethane foam has a rebound resilience of 1-80%, measured in accordance with DIN EN ISO 8307:2008-03, and/or a foam density of from 5 to 150 kg/m³ and/or a porosity, optionally after pressing open the foams, of from 1 to 50 mm water column.

15. The mattress and/or cushion according to claim 2, wherein the flexible polyurethane foam has a compressive strength CLD, 40% in accordance with DIN EN ISO 3386-1:2015-10 of from 0.1 to 8.0 kPa.

16. The mattress and/or cushion according to claim 2, wherein the flexible polyurethane foam is a hot-cured flexible polyurethane foam and preferably has a compressive strength CLD, 40% in accordance with DIN EN ISO 3386-1:2015-10 of 2.0-8.0 kPa, and/or a rebound resilience of 15-60%, measured in accordance with DIN EN ISO 8307:2008-03, and/or a foam density of from 8 to 80 kg/m³ and/or a porosity of from 1 to 50 mm water column.

17. The mattress and/or cushion according to claim 1, wherein the flexible polyurethane foam is a high-resilience flexible polyurethane foam and preferably has a compressive strength CLD, 40% in accordance with DIN EN ISO 3386-1:2015-10, of 2.5-4.5 kPa, and/or a rebound resilience of ≧55%, measured in accordance with DIN EN ISO 8307:2008-03, and/or a foam density of 25 to 80 kg/m³ and/or a porosity, after pressing open the foam, of from 1 to 50 mm water column.

18. The mattress and/or cushion according to claim 1, wherein the flexible polyurethane foam is a viscoelastic flexible polyurethane foam and has a glass transition temperature in the range from −20 to +15° C. and/or a compressive strength CLD, 40% in accordance with DIN EN ISO 3386-1:2015-10, of 0.5-2.0 kPa, and/or a rebound resilience of <10%, measured in accordance with DIN EN ISO 8307:2008-03, and/or a foam density of from 30 to 130 kg/m³ and/or a porosity, after pressing open the foam, of from 1 to 50 mm water column.

19. The mattress according to claim 2, wherein it has a height of from at least 1 cm to not more than 50 cm and a width of from at least 20 cm to not more than 300 cm.

20. The mattress according to claim 2, wherein the mattress is configured as multizone mattress.
